(19) United States
(12) Patent Application Publication
(10) Pub. No.: US 2020/0074327 A1
(43) Pub. Date: Mar. 5, 2020

(54) EVALUATION APPARATUS, EVALUATION METHOD, AND COMPUTER READABLE MEDIUM

(71) Applicant: Mitsubishi Electric Corporation, Tokyo (JP)

(72) Inventors: Takumi YAMAMOTO, Tokyo (JP); Hiroki NISHIKAWA, Tokyo (JP); Keisuke KITO, Tokyo (JP); Kiyoto KAWAUCHI, Tokyo (JP)

(73) Assignee: Mitsubishi Electric Corporation, Tokyo (JP)

(21) Appl. No.: 16/603,151

(22) PCT Filed: May 25, 2017
(86) PCT No.: PCT/JP2017/019589

§ 371 Date: Oct. 4, 2019

(51) Int. Cl. G06N 5/04; G06N 20/00; G06F 16/28; G06F 21/57

(52) U.S. Cl. CPC G06N 5/04; G06N 20/00; G06F 2221/034; G06F 21/577; G06F 16/285

(57) ABSTRACT

In an evaluation apparatus (10), a profile database (31) is a database to store profile information indicating an individual characteristic of each of a plurality of persons. A security database (32) is a database to store security information indicating a behavior characteristic of each of the plurality of persons, which may become a security incident factor. A model generation unit (22) derives a relationship between the characteristic indicated by the profile information stored in the profile database (31) and the characteristic indicated by the security information stored in the security database (32), as a model. Upon receipt of an input of information indicating a characteristic of a different person, an estimation unit (23) estimates a behavior characteristic of the different person, which may become the security incident factor, by using the model derived by the model generation unit (22).

### TECHNICAL FIELD

The present invention relates to an evaluation apparatus, an evaluation method, and an evaluation program.

### BACKGROUND ART

Attempts against cyber attacks are actively made in order to protect confidential information and assets of an organization. One of the attempts is education and training about the cyber attacks and security. There is an attempt of leaning knowledge about the cyber attacks and countermeasures against the cyber attacks in a seminar or E-learning. There is also an attempt of training a countermeasure against a targeted attack by transmission of a simulation targeted attack mail. Even if the above-mentioned attempts are made, security incident keeps on increasing.

As a report of fact-finding investigations of information leakage cases of companies that has been published by Version Business, Inc., there is Non-Patent Literature 1.

Non-Patent Literature 1 reports that, 59% of the companies which experienced information leakage did not execute security policies and procedures though they had defined the security policies and the procedures. Non-Patent Literature 1 points out that 87% of the information leakage could be prevented if appropriate countermeasures had been taken. The result of these investigations shows that no matter how many security countermeasures were introduced, an effect of the security countermeasures strongly depends on a human who is to execute the security countermeasures.

From an attacker's point of view, an attacker is anticipated to take an approach with a highest attack success rate after he has thoroughly investigated information on that organization in advance, in order to succeed an attack without being noticed by a targeted organization. Examples of the information on the organization are a system and a version of the system that are used by the organization, a point of contact with external entities, personnel information, official positions, an affiliated organization, and content of an attempt by the organization. Examples of the personnel information are a relationship with each of a supervisor, a colleague, a friend, and so on, a hobby and taste, and a usage status of a social medium.

The attacker is considered to find out a vulnerable person in the organization by using the information as mentioned above, to enter into the organization by using that vulnerable person, and to gradually intrude into the organization.

As an example, company can be taken. Generally, a staff in charge of personnel affairs, materials, or the like communicates with a person outside the organization more often than other staffs. An example of the person outside the organization is a job hunting student if the staff is in charge of the personnel affairs or is a person in a purchase destination of a material if the staff is in charge of the materials. The staff in charge of the personnel affairs, the materials, or the like is likely to receive a mail from a person with whom he has not communicated before. It can be anticipated that, if an attack mail arrives from an unknown address, the staff as mentioned above who receives a lot of mails is likely to open the attack mail without doubting about the attack mail.

It can be said that a staff who carelessly publishes the information on the organization on a social medium such as Twitter (registered trade mark) or Facebook (registered trademark) has a low level of security awareness, or in particular, a low level of awareness about information leakage. The attacker may be likely to make such a staff a first target. It is considered that, besides the careless publishing of the information on the organization, there are a lot of characteristics which are common to persons having low levels of the security awareness. Accordingly, it is necessary to perform investigation about such characteristics.

As mentioned above, vulnerability to an attack may be different according to each staff in the organization. Consequently, even if the same security education and training are uniformly performed for all staffs in the organization, a satisfactory result may not be able to be obtained. If the security education and training adapted for a staff who has a lowest level of the security awareness is performed for all the staffs, unnecessary work will be increased, so that business efficiency will be reduced.

Therefore, it is necessary to evaluate the security awareness for each staff. Then, it is necessary to improve security without reducing the business efficiency of the organization as a whole by performing appropriate security education and training for each staff who is vulnerable to the attack.

As reports of existing researches related to technologies for evaluating security awareness, there are Non-Patent Literature 2 and Non-Patent Literature 3.

In the technology described in Non-Patent Literature 2, a correlation between each questionnaire about preference disposition and each questionnaire about the security awareness is computed, thereby extracting a causal relationship between the preference disposition and the security awareness. An optimal security countermeasure for each group is presented, based on the causal relationship extracted.

In the technology described in Non-Patent Literature 3, a relation between a psychological characteristic and a behavioral characteristic when each user uses a PC is derived. “PC” is an abbreviation for “Personal Computer”. The behavioral characteristic when the PC is normally used is monitored, and the user in a psychological state of being vulnerable to a damage is determined.

### CITATION LIST

### Non-Patent Literature

Non-Patent Literature 1: Verizon Business, “2008 Data Breach Investigations Report”, [online], [searched on May 4, 2017], Internet <URL: http://www.verizonenterprise.com/resources/security/databreachreport.pdf>

Non-Patent Literature 2: Yumiko Nakazawa, Takehisa Kato, Takeo Isarida, Humiyasu Yamada, Takumi Yamamoto, Masakatsu Nishigaki, “Best Match Security—A study on correlation between preference disposition and security consciousness about user authentication”, IPSJ SIG Technical Report, Vol. 2010-CSEC-48, No. 21, 2010

Non-Patent Literature 3: Yoshinori Katayama, Takeaki Terada, Satoru Torii, Hiroshi Tsuda, “An attempt to Visualization of Psychological and Behavioral Characteristics of Users Vulnerable to Cyber Attack”, SCIS 2015, Symposium on Cryptography and Information Security, 4D1-3, 2015

Non-Patent Literature 4: NTT Software, “Training Service Against Targeted Mails”, [on line], [searched on Mar. 24, 2017], Internet <URL: https://www.ntts.co.jp/products/apttraining/index.html>

### SUMMARY OF INVENTION

### Technical Problem

In the technology described in Non-Patent Literature 2, information is collected in the form of the questionnaires. Thus, labor and time are required. Since the information of the preference disposition which is difficult to quantify is used, well-grounded interpretation of the causal relationship that has been obtained is difficult.

In the technology described in Non-Patent Literature 3, it is not necessary to implement the questionnaires for each time. However, since information of a psychological state that is difficult to quantify is used, well-grounded interpretation of the causal relationship that has been obtained is difficult.

An object of the present invention is to evaluate security awareness of an individual in a well-grounded way.

### Solution to Problem

An estimation apparatus according to an aspect of the present invention may include:

a profile database to store profile information indicating an individual characteristic of each of a plurality of persons;

a security database to store security information indicating a behavior characteristic of each of the plurality of persons, which may become a security incident factor;

a model generation unit to derive a relationship between the characteristic indicated by the profile information stored in the profile database and the characteristic indicated by the security information stored in the security database, as a model; and

an estimation unit to estimate, upon receipt of an input of information indicating a characteristic of a different person from the plurality of persons, a behavior characteristic of the different person, which may become the security incident factor, by using the model derived by the model generation unit.

### Advantageous Effects of Invention

In the present invention, the behavior characteristic of a specific person, which may become the security incident factor, is estimated as an evaluation index indicating whether the specific person is likely to encounter a security incident. Therefore, security awareness of an individual can be evaluated in a well-grounded way.

### BRIEF DESCRIPTION OF DRAWINGS

FIG. 1 is a block diagram illustrating a configuration of an evaluation apparatus according to a first embodiment.

FIG. 2 is a block diagram illustrating a configuration of an information collection unit in the evaluation apparatus according to the first embodiment.

FIG. 3 is a block diagram illustrating a configuration of a model generation unit in the evaluation apparatus according to the first embodiment.

FIG. 4 is a flowchart illustrating operations of the evaluation apparatus according to the first embodiment.

FIG. 5 is a flowchart illustrating operations of the evaluation apparatus according to the first embodiment.

FIG. 6 is a flowchart illustrating operations of the information collection unit in the evaluation apparatus according to the first embodiment.

FIG. 7 is a table illustrating examples of profile information according to the first embodiment.

FIG. 8 is a flowchart illustrating operations of the information collection unit in the evaluation apparatus according to the first embodiment.

FIG. 9 is a table illustrating examples of security information according to the first embodiment.

FIG. 10 is a flowchart illustrating operations of the model generation unit in the evaluation apparatus according to the first embodiment.

FIG. 11 is a flowchart illustrating operations of the model generation unit in the evaluation apparatus according to the first embodiment.

FIG. 12 is a flowchart illustrating operations of the model generation unit in the evaluation apparatus according to the first embodiment.

FIG. 13 is a flowchart illustrating operations of an estimation unit in the evaluation apparatus according to the first embodiment.

FIG. 14 is a block diagram illustrating a configuration of an evaluation apparatus according to a second embodiment.

FIG. 15 is a table illustrating examples of countermeasure information according to the second embodiment.

FIG. 16 is a flowchart illustrating operations of an estimation unit and a proposal unit in the evaluation apparatus according to the second embodiment.

FIG. 17 is a table illustrating an example of information indicating countermeasures according to the second embodiment.

FIG. 18 is a table illustrating another example of the information indicating the countermeasures according to the second embodiment.

FIG. 19 is a block diagram illustrating a configuration of an evaluation apparatus according to a third embodiment.

FIG. 20 is a table illustrating examples of contents of training mails according to the third embodiment.

FIG. 21 is a flowchart illustrating operations of the evaluation apparatus according to the third embodiment.

FIG. 22 is a table illustrating an example of a behavior observation result with respect to each training mail according to the third embodiment.

FIG. 23 is a block diagram illustrating a configuration of an evaluation apparatus according to a fourth embodiment.

### DESCRIPTION OF EMBODIMENTS

Hereinafter, embodiments of the present invention will be described, using the drawings. A same reference numeral is given to the same or equivalent portions in the respective drawings. In the description of the embodiments, explanation of the same or equivalent portions will be suitably omitted or simplified. The present invention is not limited to the embodiments that will be described below, and various modifications are possible as required. To take an example, two or more embodiments among the embodiments that will be described below may be carried out in combination. Alternatively, one embodiment or a combination of two or more embodiments among the embodiments that will be described below may be partially carried out.

### First Embodiment

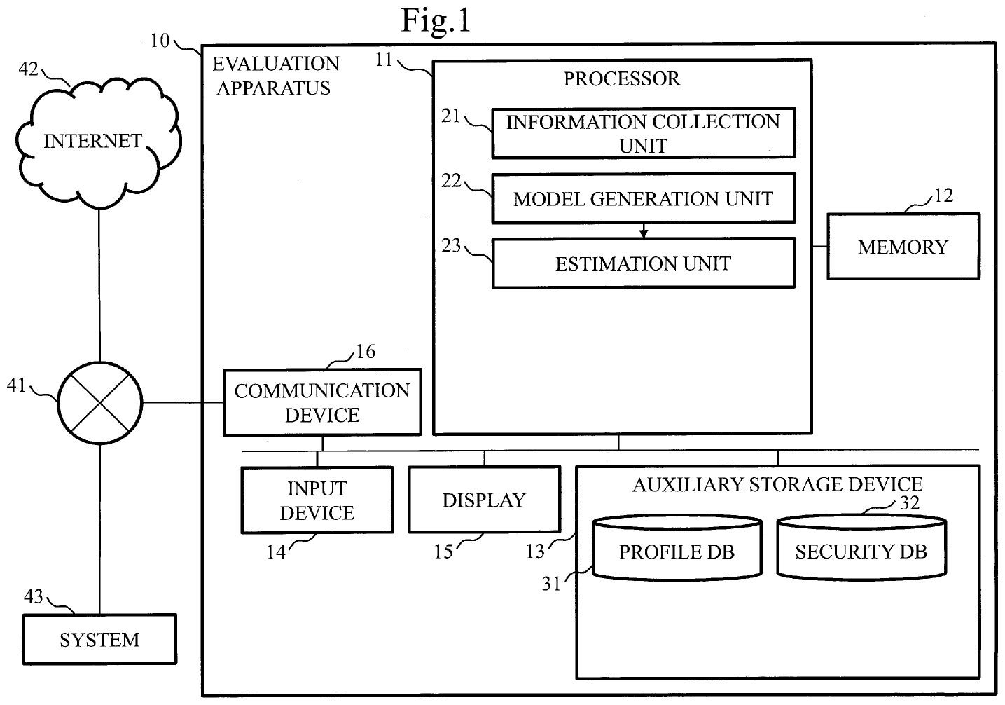

This embodiment will be described, using FIGS. 1 to 13.

Description of Configuration

A configuration of an evaluation apparatus 10 according to this embodiment will be described with reference to FIG. 1.

The evaluation apparatus 10 is connected to each of an Internet 42 and a system 43 that is operated by an organization to which a plurality of persons X₁, X₂, . . . , X_{N} belong, via a network 41. The network 41 is a LAN or a combination of the LAN and a WAN, for example. “LAN” is an abbreviation for Local Area Network. “WAN” is an abbreviation for Wide Area Network. The system 43 is an intranet, for example. Though the plurality of persons X₁, X₂, . . . , X_{N} may be arbitrary two or more persons, the plurality of persons X₁, X₂, . . . , X_{N} are staffs in the organization in this embodiment. N is an integer of two or more.

The evaluation apparatus 10 is a computer. The evaluation apparatus 10 includes a processor 11 and includes other hardware such as a memory 12, an auxiliary storage device 13, an input device 14, a display 15, and a communication device 16. The processor 11 is connected to the other hardware through signal lines and controls these other hardware.

The evaluation apparatus 10 includes an information collection unit 21, a model generation unit 22, an estimation unit 23, a profile database 31, and a security database 32. Functions of the information collection unit 21, the model generation unit 22, and the estimation unit 23 are implemented by software. Though the profile database 31 and the security database 32 may be constructed in the memory 12, the profile database 31 and the security database 32 are constructed in the auxiliary storage device 13 in this embodiment.

The processor 11 is a device to execute an evaluation program. The evaluation program is a program to implement the functions of the information collection unit 21, the model generation unit 22, and the estimation unit 23. The processor 11 is a CPU, for example. “CPU” is an abbreviation for Central Processing Unit.

Each of the memory 12 and the auxiliary storage device 13 is a device to store the evaluation program. The memory 12 is a flash memory or a RAM, for example. “RAM” is an abbreviation for Random Access Memory. The auxiliary storage device 13 is a flash memory or an HDD, for example. “HDD” is an abbreviation for Hard Disk Drive.

The input device 14 is a device that is operated by a user for an input of data to the evaluation program. The input device 14 is a mouse, a keyboard, or a touch panel, for example.

The display 15 is a device to display, on a screen, data that is output from the evaluation program. The display 15 is an LCD, for example. “LCD” is an abbreviation for Liquid Crystal Display.

The communication device 16 includes a receiver to receive the data that is input to the evaluation program from at least one of the Internet 42 and the system 43 such as the intranet via the network 41, and a transmitter to transmit the data that is output from the evaluation program. The communication device 16 is a communication chip or an NIC, for example. “NIC” is an abbreviation for Network Interface Card.

The evaluation program is loaded into the memory 12 from the auxiliary storage device 13, is loaded into the processor 11, and is then executed by the processor 11. An OS as well as the evaluation program is stored in the auxiliary storage device 13. “OS” is an abbreviation for “Operating System”. The processor 11 executes the evaluation program while executing the OS.

A part or all of the evaluation program may be incorporated into the OS.

The evaluation apparatus 10 may include a plurality of processors that substitute the processor 11. These plurality of processors share execution of the evaluation program. Each processor is a device to execute the evaluation program, like the processor 11.

Data, information, signal values, and variable values that are used, processed, or output by the evaluation program are stored in the memory 12, the auxiliary storage device 13, or a register or a cache memory in the processor 11.

The evaluation program is a program to cause a computer to execute processes where “units” of the information collection unit 21, the model generation unit 22, and the estimation unit 23 are read as the “processes” or steps where the “units” of the information collection unit 21, the model generation unit 22, and the estimation unit 23 are read as the “steps”. The evaluation program may be recorded in a computer-readable medium and then may be provided or may be provided as a program product.

The profile database 31 is a database to store profile information. The profile information is information indicating an individual characteristic of each of the plurality of persons X₁, X₂, . . . , X_{N}.

The security database 32 is a database to store security information. The security information is information indicating a behavior characteristic of each of the plurality of persons X₁, X₂, . . . , X_{N} that may become a factor of a security incident.

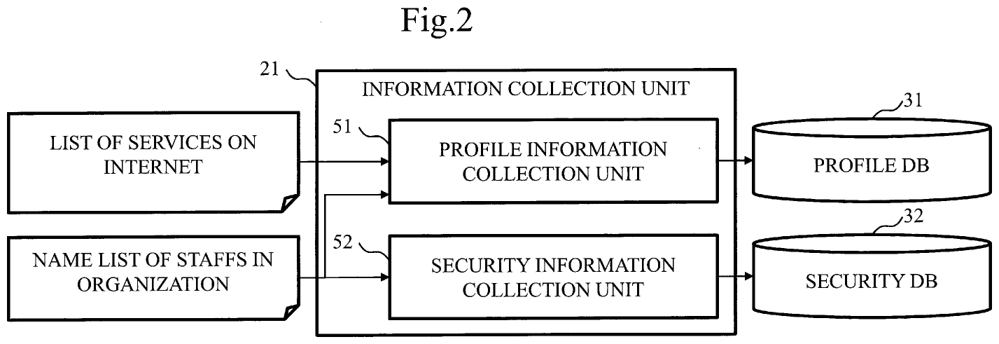

A configuration of the information collection unit 21 will be described with reference to FIG. 2.

The information collection unit 21 includes a profile information collection unit 51 and a security information collection unit 52.

A list of services on the Internet 42 that become targets for crawling or scraping and a name list of the staffs in the organization are input to the profile information collection unit 51. The profile information is output to the profile database 31 from the profile information collection unit 51, as a result of a process that will be described later.

The name list of the staffs in the organization is input to the security information collection unit 52. The security information is output to the security database 32 as a result of a process that will be described later.

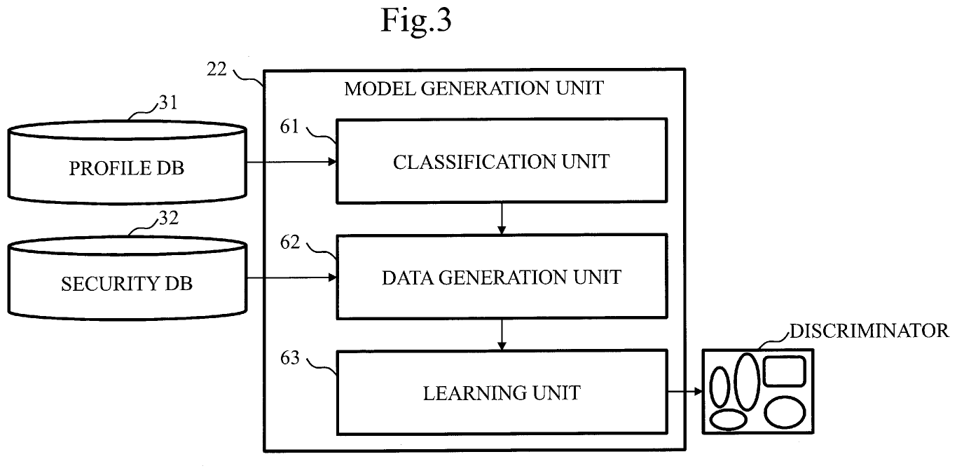

A configuration of the model generation unit 22 will be described with reference to FIG. 3.

The model generation unit 22 includes a classification unit 61, a data generation unit 62, and a learning unit 63.

The profile information stored in the profile database 31 is input to the classification unit 61.

The security information stored in the security database 32 and a result of a process executed by the classification unit 61 are input to the data generation unit 62.

A result of a process executed by the data generation unit 62 is input to the learning unit 63. A discriminator is output from the learning unit 63 as a result of a process that will be described later.

Description of Operations

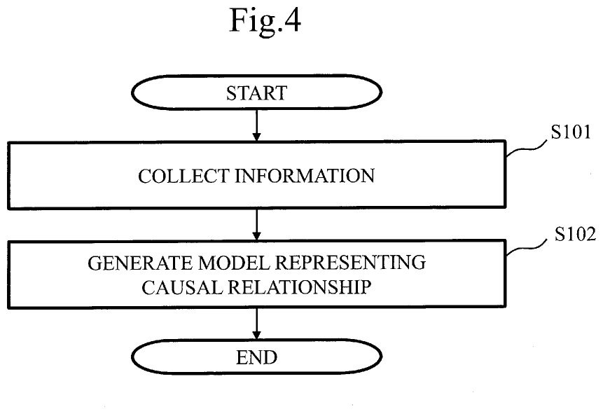

Operations of the evaluation apparatus 10 according to this embodiment will be described with reference to FIGS. 4 to 13 together with FIGS. 1 to 3. The operations of the evaluation apparatus 10 correspond to an evaluation method according to this embodiment.

FIG. 4 illustrates operations of a learning phase.

In step S101, the information collection unit 21 collects profile information from at least one of the Internet 42 and the system 43 such as the intranet. In this embodiment, the information collection unit 21 collects the profile information from both of the Internet 42 and the system 43 such as the intranet. The information collection unit 21 stores, in the profile database 31, the profile information collected.

The information collection unit 21 collects security information from the system 43. The information collection unit 21 stores, in the security database 32, the security information collected.

As mentioned above, the information collection unit 21 collects information on the staffs in the organization. The information that is collected is roughly constituted from two types that are the profile information and the security information.

The profile information is constituted from two types which are organization profile information that can automatically be collected by a manager or an IT manager of the organization and disclosed profile information that is disclosed on the Internet 42. “IT” is an abbreviation for Information Technology.

The organization profile information includes information such as a gender, an age, a belonging department, a supervisor, reliabilities of mail transmission and reception, a frequency of use of the Internet 42, a time to come office, and a time to leave office. The organization profile information is information to which the manager or the IT manager of the organization can make access. The organization profile information can be automatically collected.

The disclosed profile information includes information such as a frequency of use of one or more services on the Internet 42 and an amount of personal information that is disclosed. The disclosed profile information is collected from the site of each service on the Internet 42 for which the crawling or the scraping is permitted. By analyzing information that has been obtained by the crawling or the scraping, information related to one or more interests of an individual is extracted. Specifically, a page including the name or the mail address of an individual is collected from the site of the service on the Internet 42. A natural language processing technology such as a TF-IDF is utilized, so that a term that becomes a key in the page collected is picked up. The information related to the individual's interest is generated from the term that has been picked up. The information generated is also treated as a part of the disclosed profile information. “TF” is an abbreviation for Term Frequency. “IDF” is an abbreviation for “Inverse Document Frequency”. The disclosed profile information can also be collected by combining Maltego CE or theHarverster that is an existing technology.

The security information indicates the number of signs of a security incident related to a cyber attack. Examples of the number as mentioned above are the number of training mail openings, the number of malware detections, the number of malicious site visits, the number of policy violations, the number of execution file downloadings, the number of file downloadings, and the number of Internet uses. The number of the training mail openings is indicated by a rate of opening a file attached to each training mail by an individual person, a rate of clicking on a URL in the training mail by the individual person, or the sum of those rates. URL is an abbreviation for Uniform Resource Locator. The training mail is a mail for training against the security incident. The number of the training mail openings may be indicated by the number of times rather than the rate. The number of the malicious site visits is the number of times where the individual person has been warned by a malicious site detection system. The number of the policy violations is the number of times of the policy violations by the individual person. The security information is information that can be accessed by the IT manager or the security manager of the organization. The security information can be automatically collected.

In step S102, the model generation unit 22 derives a relationship between each characteristic indicated by the profile information stored in the profile database 31 and each characteristic indicated by the security information stored in the security database 32, as a model.

Specifically, the model generation unit 22 performs clustering of the profile information stored in the profile database 31, thereby classifying the plurality of persons X₁, X₂, . . . , X_{N} into some clusters. For each cluster, the model generation unit 22 generates learning data from the profile information and generates, from the security information, a label to be given to the learning data. The model generation unit 22 derives the model for each cluster, by using the learning data and the label that have been generated.

Though not essential, preferably, the model generation unit 22 computes a correlation between each characteristic indicated by the profile information and each characteristic indicated by the security information, and excludes, from the profile information, the information indicating the characteristic for which the correlation computed is less than a threshold value θ_{c1}, before deriving the model.

Though not essential, preferably, the model generation unit 22 computes the correlation between each characteristic indicated by the profile information and each characteristic indicated by the security information, and excludes, from the security information, the information indicating the characteristic for which the correlation computed is less than a threshold value θ_{c2}, before deriving the model.

As mentioned above, the model generation unit 22 generates the model representing the relationship between the profile information and the security information. The model represents the relationship between the type of the security incident and the tendency of the person indicated by the profile information, who is likely to cause the security incident of this type. The model generation unit 22 may compute the correlation between the profile information and the security information in advance and may exclude a non-correlated item.

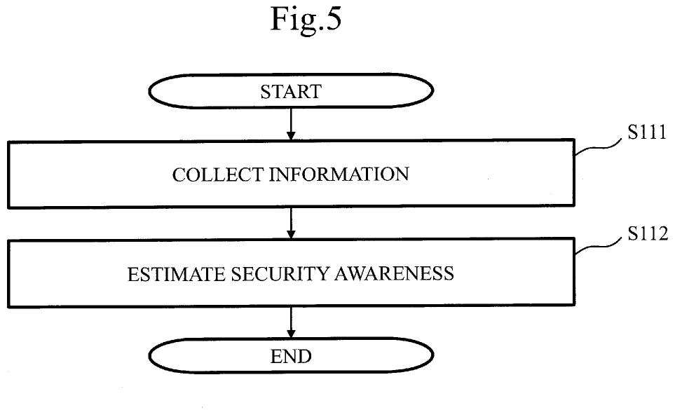

FIG. 5 illustrates operations of an evaluation phase that is a phase subsequent to the learning phase.

In step S111, the estimation unit 23 receives an input of information indicating a characteristic of a person Y who is different from the plurality of persons X₁, X₂, . . . , X_{N}. In this embodiment, the estimation unit 23 receives, from the information collection unit 21, the input of the information collected in the same procedure as that in step S101.

As mentioned above, the information collection unit 21 collects profile information of a user whose security awareness is to be evaluated. The information collection unit 21 inputs, to the estimation unit 23, the profile information collected.

In step S112, the estimation unit 23 estimates a behavior characteristic of the person Y, which may become a security incident factor, by using the model that has been derived by the model generation unit 22.

As mentioned above, the estimation unit 23 estimates what type of security incident the user whose security awareness is to be evaluated is likely to cause, by using the model generated in step S102 and the profile information collected in step S111.

Hereinafter, operations of the information collection unit 21, the model generation unit 22, and the estimation unit 23 in the evaluation apparatus 10 will be described in detail.

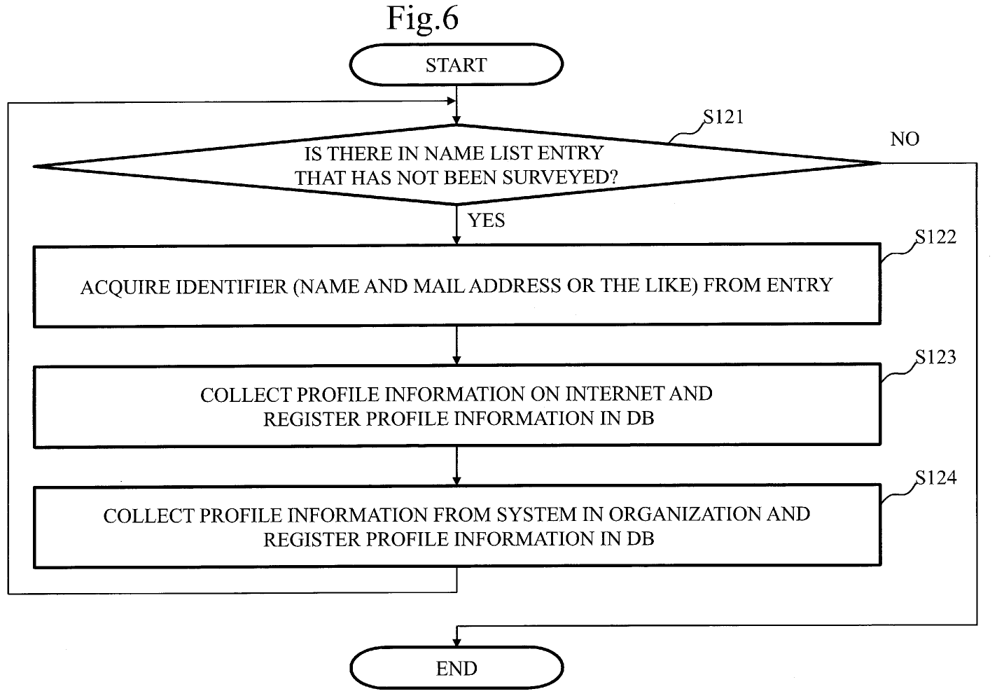

FIG. 6 illustrates a processing flow of the profile information collection unit 51 in the information collection unit 21.

In step S121, the profile information collection unit 51 checks whether there is, in the name list of the staffs in the organization, an entry that has not been surveyed. The name list includes an identifier such as the name and the mail address of each staff. If there is not the entry that has not been surveyed, the profile information collection unit 51 finishes information collection. If there is the entry that has not been surveyed, the profile information collection unit 51 executes a process in step S122.

In step S122, the profile information collection unit 51 acquires an identifier IDN from the entry that has not been surveyed. An example of the identifier IDN is the name and the mail address or the like.

In step S123, the profile information collection unit 51 searches for the identifier IDN on the Internet 42. The profile information collection unit 51 collects, from information of a page including the identifier IDN, information related to one or more interests of an individual, in addition to information such as the frequency of use of one or more services on the Internet 42 and an amount of personal information that is disclosed, as profile information. The profile information collection unit 51 registers, in the profile database 31, the disclosed profile information that has been obtained. The profile information collection unit 51 also acquires information such as the number of times of uploading in social network service, an amount of personal information that is disclosed in the social network service, and the content of an article that is posted in the social network service, as the disclosed profile information.

The profile information collection unit 51 computes the amount of the personal information that is disclosed, based on whether or not information related to the name, an acquaintance relationship, the name of the organization, contact information, and the address can be acquired from disclosed information. The profile information collection unit 51 utilizes the natural language processing technology such as a BoW or the TF-IDF for the information related to the one or more interests of the individual, thereby picking up a term having a high occurrence frequency and a term having a significant meaning in the page from which the collection has been performed. “BoW” is an abbreviation for Bag of Words.

If an identifier IDN′ that is information of a person different from the person having the Identifier IDN is described in the same page, the profile information collection unit 51 regards that there is a relationship between the identifier IDN and the identifier IDN′. The profile information collection unit 51 acquires the identifier IDN′ as information related to the acquaintance relationship.

In step S124, the profile information collection unit 51 searches for the identifier IDN in the system 43 in the organization. The profile information collection unit 51 registers, in the profile database 31, organization profile information that has been obtained. Specifically, the profile information collection unit 51 collects information associated with the identifier IDN, such as a department, a supervisor, a subordinate, and a schedule, as the organization profile information. The profile information collection unit 51 executes the process in step S121 again after the process in step S124.

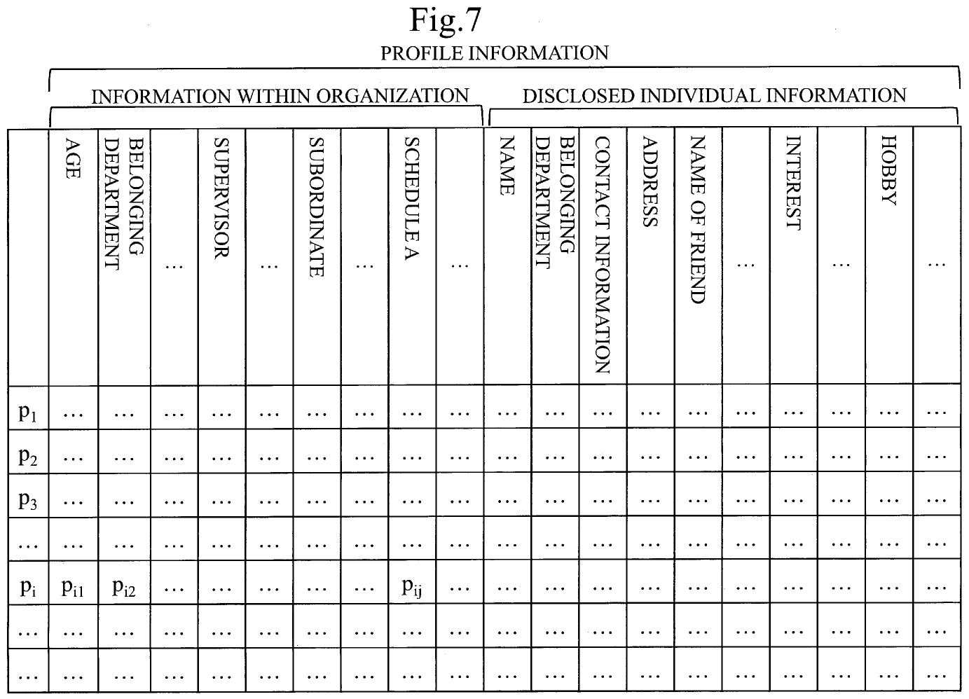

Examples of the profile information are illustrated in FIG. 7. The profile information that has been collected is represented by a multi-dimensional vector as follows:

pᵢⱼ ∈ ProfileInfoDB

where i is an integer that satisfies 1=>i= [symbol] N, in which N is the number of samples, and j is an integer that satisfies 1= [symbol] j= [symbol] P, in which P indicates types of the characteristics.

Since the profile information to be collected is related to privacy as well, it is desirable to determine what to acquire after thorough discussion has been made in the organization.

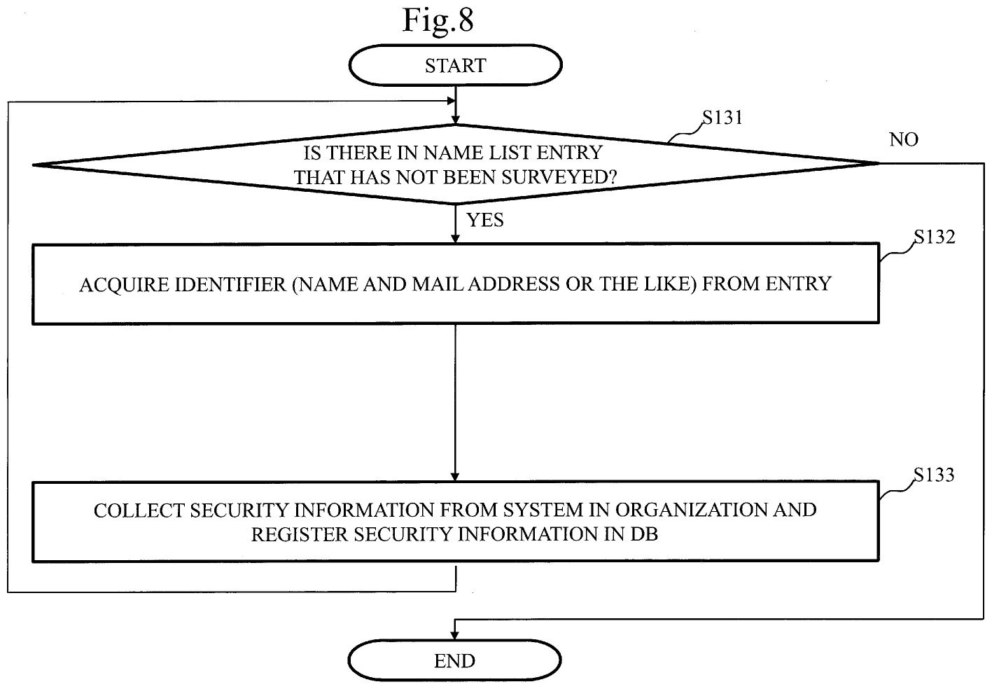

FIG. 8 illustrates a processing flow of the security information collection unit 52 in the information collection unit 21.

In step S131, the security information collection unit 52 checks whether there is, in the name list of the staffs in the organization, an entry that has not been surveyed. If there is not the entry that has not been surveyed, the security information collection unit 52 finishes information collection. If there is the entry that has not been surveyed, the security information collection unit 52 executes a process in step S132.

In step S132, the security information collection unit 52 acquires the identifier IDN from the entry that has not been surveyed.

In step S133, the security information collection unit 52 searches for the identifier IDN in the system 43 in the organization. The security information collection unit 52 registers, in the security database 32, security information that has been obtained. Specifically, the security information collection unit 52 searches for the identifier IDN in a log database related to a security incident in the organization. The log database is a database that can be accessed by the IT manager or the security manager of the organization. The number of training mail openings, the number of malware detections, the number of malicious site visits, the number of policy violations, and so on are recorded in the log database. The security information collection unit 52 executes the process in step S131 again after the process in step S133.

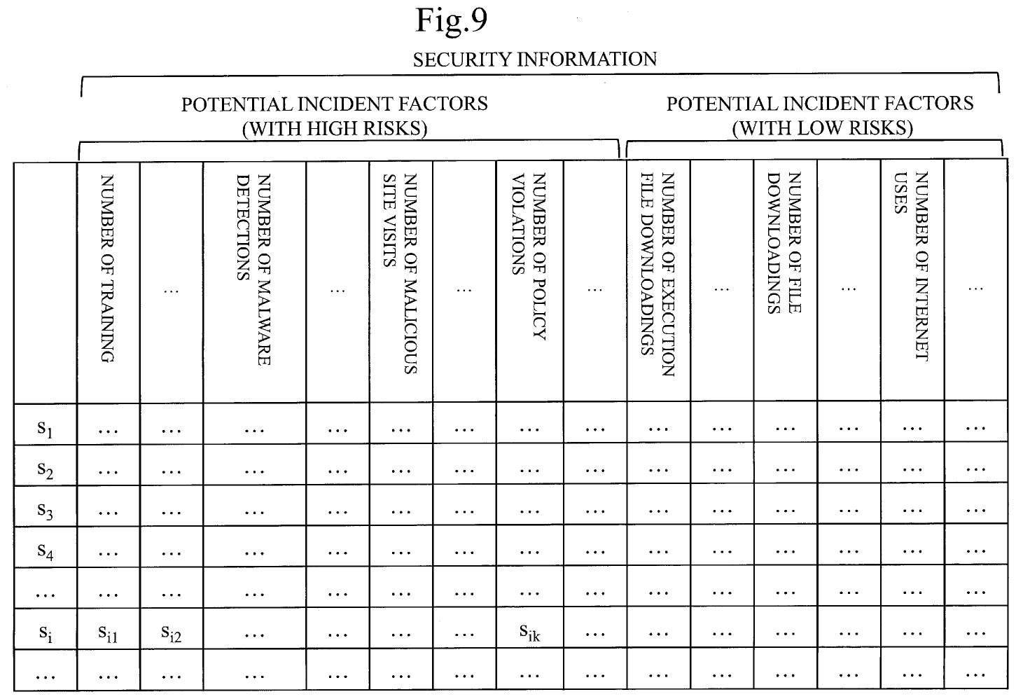

Examples of the security information are illustrated in FIG. 9. The security information that has been collected is represented by a multi-dimensional vector as follows:

sᵢₖ ∈ SecurityInfoDB

where i is the integer that satisfies 1= [symbol] i= [symbol] N, in which N is the number of the samples, and k is an integer that satisfies 1= [symbol] k= [symbol] S, in which S indicates types of the characteristics,

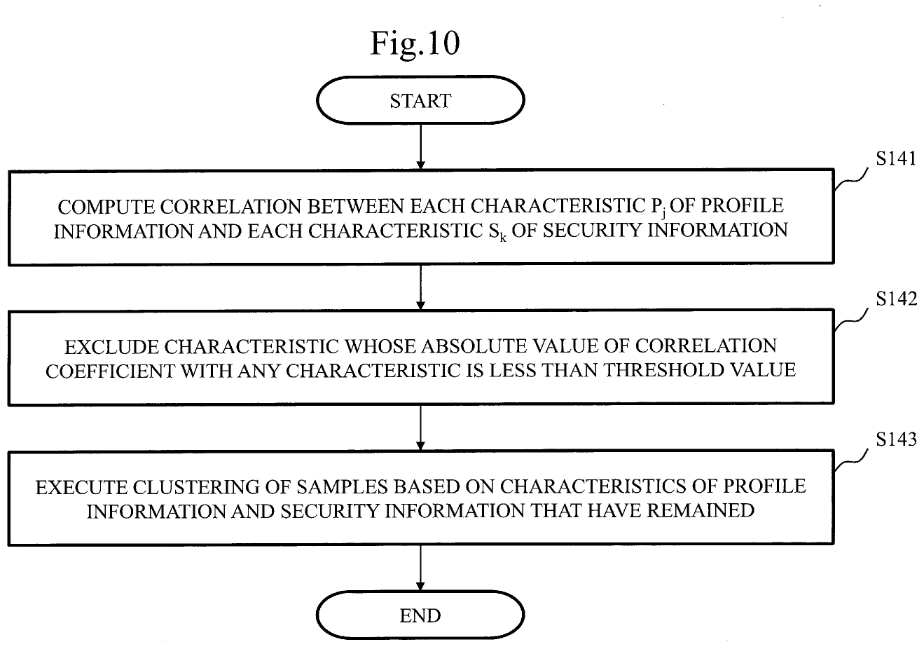

FIG. 10 illustrates a processing flow of the classification unit 61 in the model generation unit 22.

In step S141, the classification unit 61 computes a correlation between each characteristic pⱼ of the profile information and each characteristic sₖ of the security information. As mentioned above, j is the integer that satisfies 1= [symbol] j= [symbol] P. k is the integer that satisfies 1= [symbol] k= [symbol] S. Specifically, the classification unit 61 computes a correlation coefficient corrⱼₖ by using the following expression:

corrⱼₖ=σₚₛ/(σₚσₛ)

where σₚₛ is a covariance between pⱼ and sₖ, σₚ is a standard deviation of pⱼ, and σₛ is a standard deviation of sₖ. pⱼ is a vector corresponding to a characteristic row of a jth type. The number of dimensions of this vector is N. sₖ is a vector corresponding to a characteristic row of a kth type. The number of dimensions of this vector is also N.

In step S142, the classification unit 61 excludes a characteristic pⱼ: ∀k (|corrⱼₖ|<θ_{c1}) of the profile information whose absolute value of the correlation coefficient with any characteristic of the security information is less than the threshold value θ_{c1} defined in advance, and generates profile information that is correlated with the security information. This profile information is represented by a following multi-dimensional vector:

p′ᵢⱼ ∈ ProfileInfoDB′

where i is the integer that satisfies 1= [symbol] i= [symbol] N, in which N is the number of the samples, and j is an integer that satisfies 1= [symbol] j= [symbol] P′, in which P′ indicates types of the characteristics.

Similarly, the classification unit 61 excludes a characteristic sₖ: ∀j (|corrⱼₖ|<θ_{c2}) of the security information whose absolute value of the correlation coefficient with any characteristic of the profile information is less than the threshold value θ_{c2} defined in advance, and generates security information that is correlated with the profile information. This security information is represented by a following multi-dimensional vector:

s′ᵢₖ ∈ SecurityInfoDB′

where i is the integer that satisfies 1= [symbol] i= [symbol] N, in which N is the number of the samples, and k is an integer that satisfies 1= [symbol] k= [symbol] S′, in which S′ indicates types of the characteristics.

The processes in step S141 and step S142 are processes for improving accuracy when the model is generated, and therefore the processes in step S141 and step S142 may be omitted if the accuracy is high. That is, the ProfileInfoDB may be used as the ProfileInfoDB′ without alteration. The securityInfoDB may be used as the SecurityInfoDB′ without alteration.

In step S143, the classification unit 61 performs clustering of the samples of each of the ProfileInforDB′ and the SecurityInfoDB′ based on the information of the characteristics and classifies N samples into C clusters. Each cluster is represented by the following multi-dimensional vector:

cₘ ∈ Clusters

where m is an integer that satisfies 1= [symbol] m= [symbol] C.

Each cluster cₘ is represented by a group of pairs between the profile information and the security information of the samples for which the clustering has been performed.

cₘ{(pᵢ, sᵢ)|i ∈ CIₘ}

where pᵢ is a vector that is constituted from P′ types of character information, sᵢ is a vector that is constituted from S′ types of character information, and CIₘ is a group of indices of the samples that have been classified into each cₘ by the clustering.

The classification unit 61 basically performs the clustering based on the characteristics of the ProfileInforDB′. One or more characteristics of the Security InfoDB′ can be, however included. As an algorithm for the clustering, a common algorithm such as a K-means method, or an original algorithm can be used.

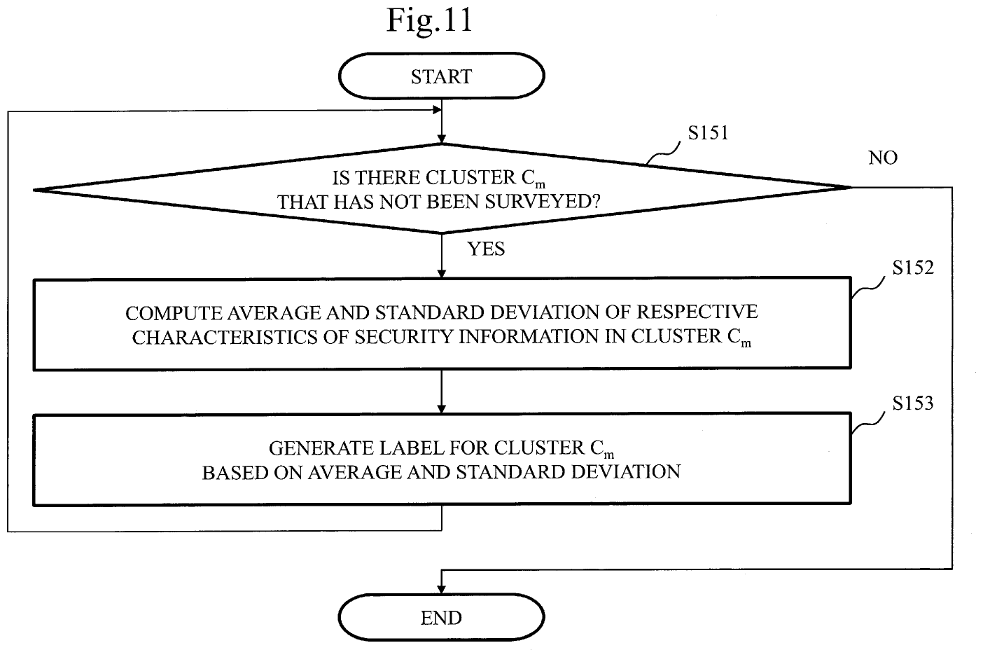

FIG. 11 illustrates a processing flow of the data generation unit 62 in the model generation unit 22.

In step S151, the data generation unit 62 checks whether there is the cluster cₘ that has not been surveyed. As mentioned above, 1= [symbol] m= [symbol] C holds. If there is not the cluster cₘ that has not been surveyed, the data generation unit 62 finishes data generation. If there is the cluster cₘ that has not been surveyed, the data generation unit 62 executes a process in step S152.

In step S152, the data generation unit 62 computes an average SecurityInfoAve (cₘ) of respective characteristics of security information in the cluster cₘ that has not been surveyed. The average SecurityInfoAve (cₘ) is defined as follows:

SecurityInfoAve (cₘ)=(ave (s₁), ave (s₂), . . . , ave (sₖ), . . . , ave (s_{s′-1}), ave (s_{s′})

The average ave (sₖ) of each characteristic sₖ of the security information is computed, by using the following expression:

$$ave ( {s}_{k} ) = \frac{{\sum }_{i ∈ {CI}_{m}} {s}_{ik}}{\vert {CI}_{m} \vert} \qquad [ Expression 1 ]$$

where |CIₘ| indicates the number of the samples that have been classified into the cₘ by the clustering.

The data generation unit 62 computes a standard deviation SecurityInfoStdv (cₘ) of each characteristic of the security information in the cluster cₘ that has not been surveyed. The standard deviation SecurityInfoStdv (cₘ) is defined as follows:

SecurityInfoStdv (cₘ)=(stdv (s₁), stdv (s₂), . . . , stdv (sₖ), . . . , stdv (s_{s′-1}), stdv (s_{s′}))

The standard deviation stdv (sₖ) of each characteristic sₖ of the security information is computed by using the following expression:

$$stdv ( {s}_{k} ) = \sqrt{\frac{{\sum }_{i ∈ {CI}_{m}} {( {s}_{ik} - ave ( {s}_{k} ) )}^{2}}{\vert {CI}_{m} \vert}} \qquad [ Expression 2 ]$$

In step S153, the data generation unit 62 generates a label LAB (cₘ) that represents the cluster cₘ, based on the average SecurityInfoAve (cₘ) and the standard deviation SecurityInfoStdv (cₘ). The label LAB (cₘ) is defined as follows:

LAB (cₘ)=(lab (s₁), lab (s₂), . . . , lab (sₖ), . . . , lab (s_{s′-1}), lab (s_{s′}))

A label element lab (sₖ) of each characteristic sₖ of the security information is set to be the average ave (sₖ) if the standard deviation stdv (sₖ) is held within a range defined in advance for each characteristic of the security information. Otherwise, the label element lab (sₖ) is set to be “None”. After the process in step S153, the data generation unit 62 executes the process in step S151 again.

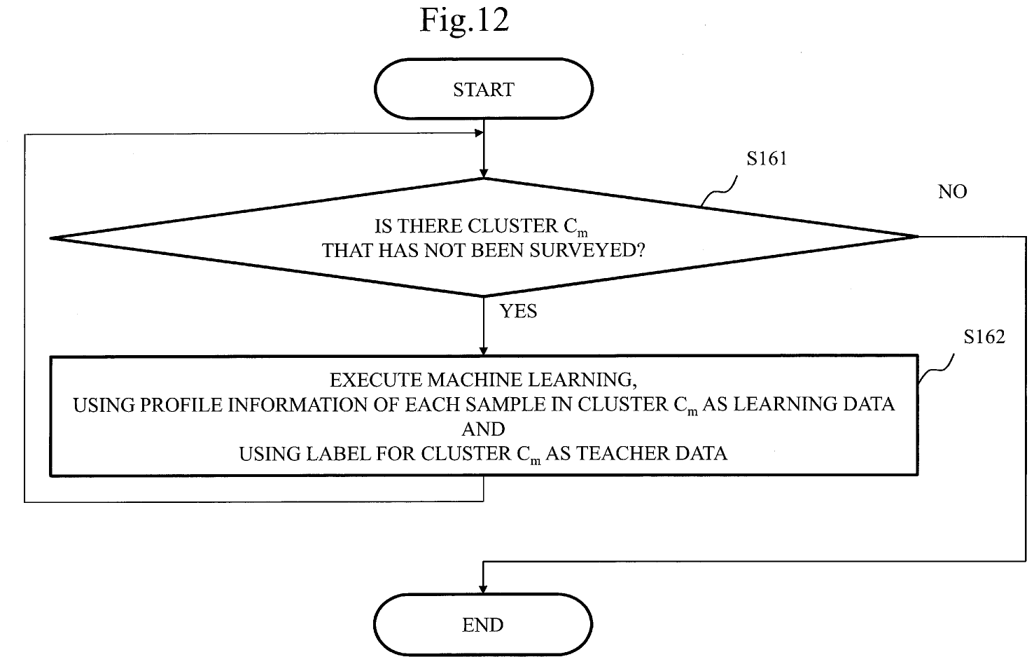

FIG. 12 illustrates a processing flow of the learning unit 63 in the model generation unit 22.

In step S161, the learning unit 63 checks whether there is the cluster cₘ that has not been surveyed. As mentioned above, 1= [symbol] m= [symbol] C holds. If there is not the cluster cₘ that has not been surveyed, the learning unit 63 finishes learning. If there is the cluster cₘ that has not been surveyed, the learning unit 63 executes a process in step S162.

In step S162, the learning unit 63 executes machine learning, using profile information pᵢ of each element in the cluster cₘ that has not been surveyed as learning data and using the label LAB (cₘ) as teacher data. In actual learning, a numeral that is different for each label is assigned to the label LAB (cₘ). The learning unit 63 outputs a discriminator that is the model, as a result of the execution of the machine learning. The learning unit 63 executes the process in step S161 again after the process in step S162.

The learning unit 63 may learn the data using the entirety of the label LAB (cₘ) as one label, but the learning unit 63 may learn the data for each label element lab (sₖ). In that case, a label element that has a same value or a close value may appear in a different cluster as well. Therefore, the learning unit 63 may replace each label element lab (sₖ) that is held in the range defined in advance by a prescribed label element and may learn the data using the label element after the replacement. The “prescribed label element” is a numeral or the like that is different for each label element.

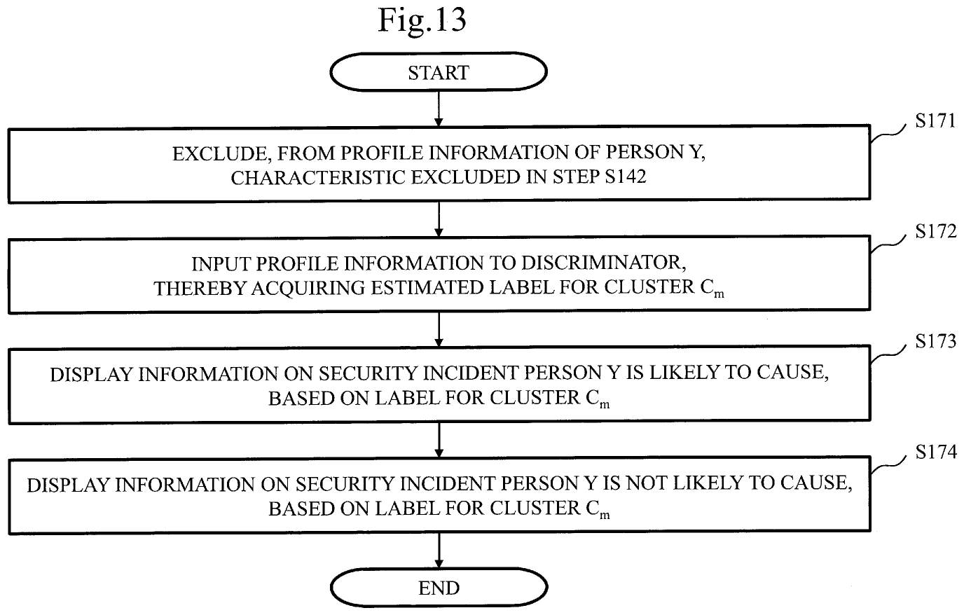

FIG. 13 illustrates a processing flow of the estimation unit 23.

Processes from step S171 to step S174 correspond to the process in step S112 described above. Accordingly, before the process in step S171, the process in step S111 described above is executed. In step S111, the estimation unit 23 acquires new profile information by using the information collection unit 21. This profile information is the profile information of the person Y whose security awareness is to be estimated.

In step S171, the estimation unit 23 excludes, from the profile information of the person Y, a characteristic which is the same as that excluded in step S142.

In step S172, the estimation unit 23 inputs the profile information that has been obtained in step S171 to the discriminator output from the model generation unit 22, thereby acquiring the label LAB (cₘ) for the cluster cₘ, which has been estimated.

In step S173, the estimation unit 23 identifies, from the label LAB (cₘ) that has been obtained in step S172, a security incident the person Y is likely to cause. Specifically, when the label element (sₖ) that constitutes the label LAB (cₘ) is not “None” and is equal to or more than a threshold value θₖ₁ defined in advance for each characteristic of the security information, the estimation unit 23 determines that the person Y is likely to cause the security incident related to the characteristic sₖ. The estimation unit 23 displays, on the screen of the display 15, information on the security incident the person Y is likely to cause.

In step S174, the estimation unit 23 identifies, from the label LAB (cₘ) that has been obtained in step S172, a security incident the person Y is not likely to cause. Specifically, when the label element (sₖ) that constitutes the label LAB (cₘ) is not “None” and is equal to or less than a threshold value θₖ₂ defined in advance for each characteristic of the security information, the estimation unit 23 determines that the person Y is not likely to cause the security incident related to the characteristic sₖ. The estimation unit 23 displays, on the screen of the display 15, information on the security incident the person Y is not likely to cause.

Description of Effects of Embodiment

In this embodiment, as an evaluation index indicating whether the person Y is likely to encounter the security incident, the behavior characteristic that may become the security incident factor with respect to the person Y is estimated as the label LAB (cₘ). Therefore, security awareness of an individual can be evaluated in a well-grounded way.

According to this embodiment, it can be automatically estimated what type of the security incident a user targeted for the evaluation is likely to cause, by using information that can be automatically collected from the Internet 42 and the system 43 such as the intranet.

In this embodiment, the organization can consider a countermeasure, based on a result of the estimation of what type of the security incident the person Y is likely to cause.

Alternative Configuration

In this embodiment, the functions of the information collection unit 21, the model generation unit 22, and the estimation unit 23 are implemented by the software. However, as a variation example, the functions of the information collection unit 21, the model generation unit 22, and the estimation unit 23 may be implemented by a combination of software and hardware. That is, a part of the functions of the information collection unit 21, the model generation unit 22, and the estimation unit 23 may be implemented by dedicated hardware and the remainder of the functions of the information collection unit 21, the model generation unit 22, and the estimation unit 23 may be implemented by software.

The dedicated hardware is a single circuit, a composite circuit, a programmed processor, a parallel-programmed processor, a logic IC, a GA, an FPGA, or an ASIC, for example. “IC” is an abbreviation for Integrated Circuit. “GA” is an abbreviation for Gate Array. “FPGA” is an abbreviation for Field-Programmable Gate Array. “ASIC” is an abbreviation for Application Specific Integrated Circuit.

Both of the processor 11 and the dedicated hardware are processing circuits. That is, irrespective of whether the functions of the information collection unit 21, the model generation unit 22, and the estimation unit 23 are implemented by the software or the combination of the software and the hardware, the functions of the information collection unit 21, the model generation unit 22, and the estimation unit 23 are implemented by the processing circuit(s).

### Second Embodiment

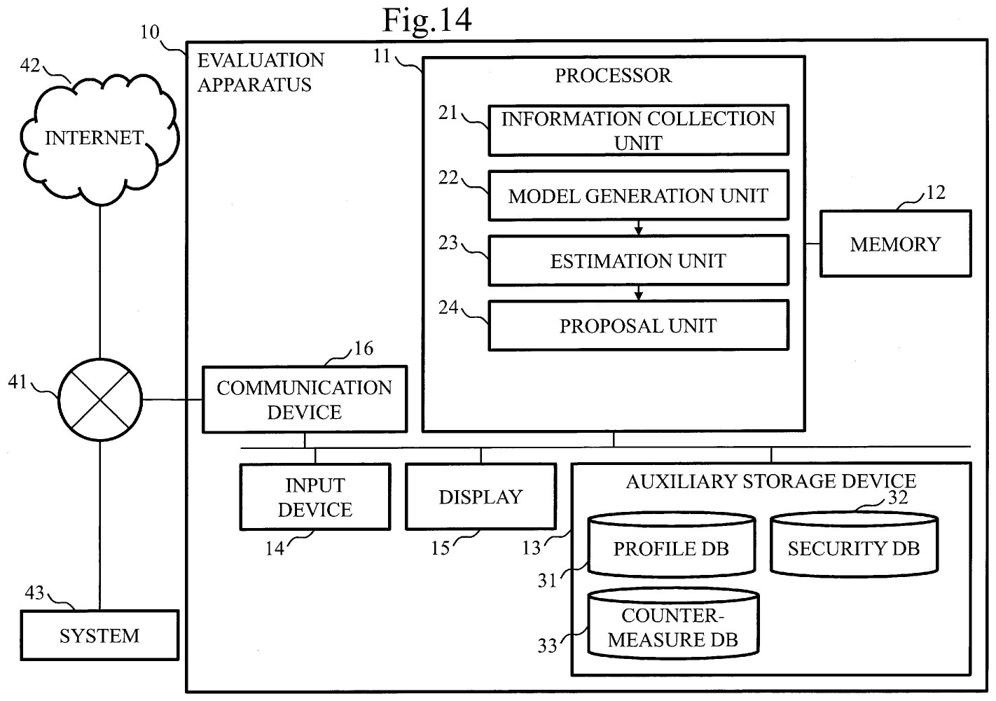

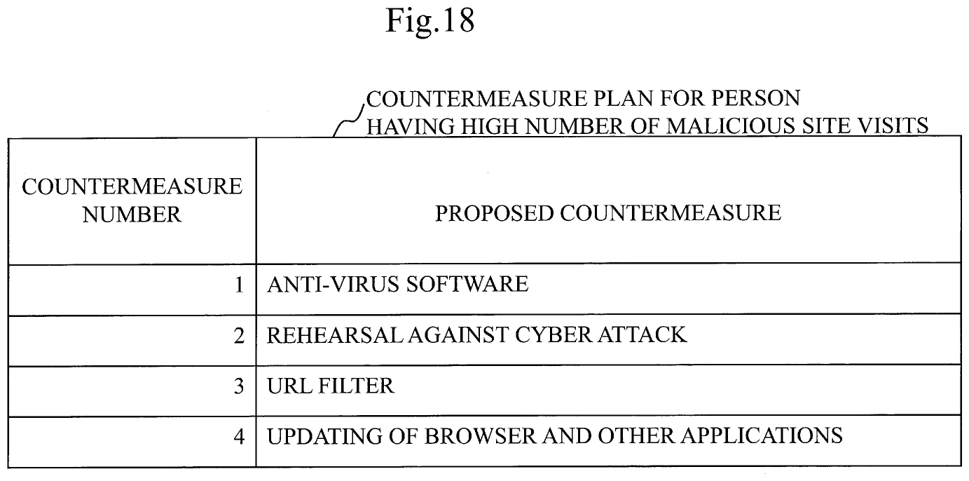

In this embodiment, a difference from the first embodiment will be mainly described, using FIGS. 14 to 18.

In the first embodiment, it is assumed that the organization considers the countermeasure, based on the result of the estimation of what type of the security incident the person Y is likely to cause. On the other hand, in this embodiment, a countermeasure suited to a person Y is automatically proposed, based on a result of estimation of what type of a security incident the person Y is likely to cause.

Description of Configuration

A configuration of an evaluation apparatus 10 according to this embodiment will be described with reference to FIG. 14.

The evaluation apparatus 10 includes a proposal unit 24 and a countermeasure database 33, in addition to an information collection unit 21, a model generation unit 22, an estimation unit 23, a profile database 31, and a security database 32. Functions of the information collection unit 21, the model generation unit 22, the estimation unit 23, and the proposal unit 24 are implemented by software. Though the profile database 31, the security database 32, and the countermeasure database 33 may be constructed in a memory 12, the profile database 31, the security database 32, and the countermeasure database 33 are constructed in an auxiliary storage device 13.

The countermeasure database 33 is a database to store countermeasure information. The countermeasure information is information to define one or more countermeasures against a security incident.

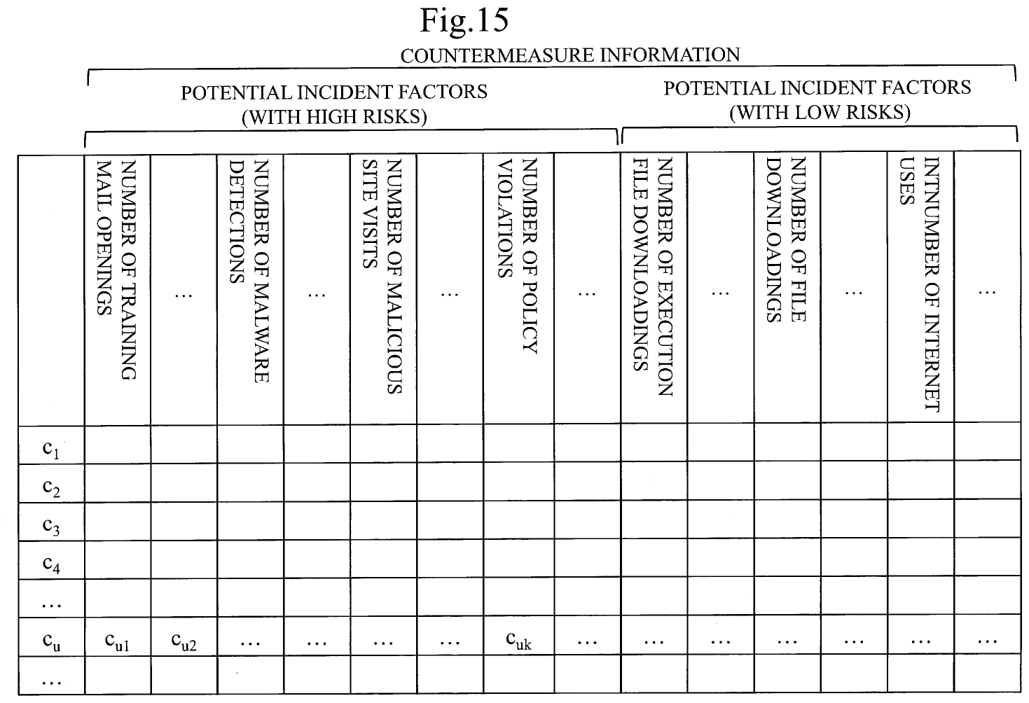

Examples of the countermeasure information are illustrated in FIG. 15. In these examples, a list of security countermeasures that are effective for a person whose each characteristic sₖ of security information is high is recorded in the countermeasure database 33 as the countermeasure information. The countermeasure information is defined by a security manager in advance.

Description of Operations

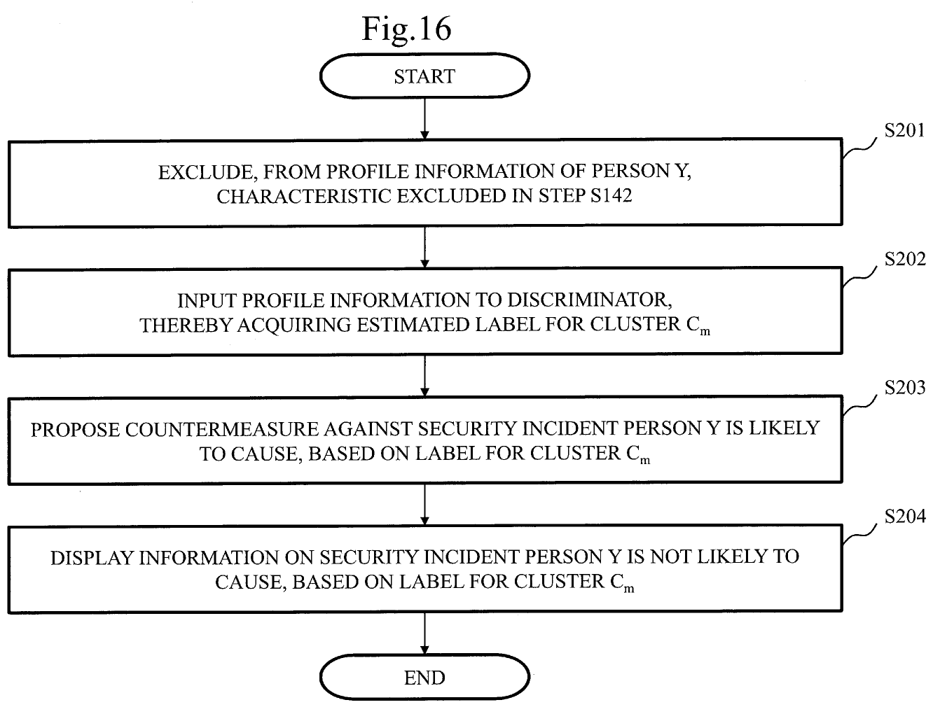

Operations of the evaluation apparatus 10 according to this embodiment will be described with reference to FIGS. 16 to 18, together with FIGS. 14 and 15. The operations of the evaluation apparatus 10 correspond to an evaluation method according to this embodiment.

Since the operations of the information collection unit 21 and the model generation unit 22 in the evaluation apparatus 10 are the same as those in the first embodiment, description of the operations of the information collection unit 21 and the model generation unit 22 will be omitted.

Hereinafter, the operations of the estimation unit 23 and the proposal unit 24 in the evaluation apparatus 10 will be described.

FIG. 16 illustrates a processing flow of the estimation unit 23 and the proposal unit 24.

Since processes in step S201 and step S202 are the same as the processes in step S171 and step S172, description of the processes in step S201 and step S200 will be omitted.

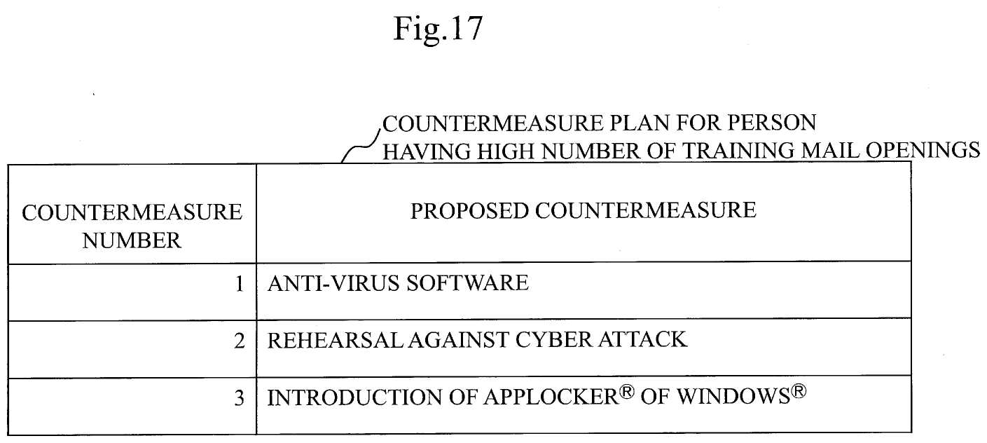

In step S203, the proposal unit 24 identifies a countermeasure against a security incident that may be caused by a behavior indicating a characteristic which has been estimated by the estimation unit 23 as a factor, by referring to countermeasure information stored in the countermeasure database 33. Specifically, the proposal unit 24 identifies the countermeasure against the security incident a person Y is likely to cause, based on a label LAB (cₘ) acquired by the estimation unit 23 in step S202 by using profile information of the person Y and the countermeasure information stored in the countermeasure database 33. More specifically, when a label element lab (sₖ) that constitutes the label LAB (cₘ) is not “None” and is equal to or more than a threshold value θₖ₁ defined in advance for each characteristic of the security information, the proposal unit 24 determines that a countermeasure suited to the person Y is a countermeasure against the security incident related to a characteristic sₖ. The proposal unit 24 outputs information indicating the countermeasure identified. Specifically, the proposal unit 24 displays, on the screen of a display 15, a countermeasure plan against the security incident the person Y is likely to cause. An example of a countermeasure plan for a person having a high number of training mail openings and an example of a countermeasure plan for a person having a high number of malicious site visits are respectively illustrated in FIG. 16 and FIG. 17.

Since a process in step S204 is the same as the process in step S174, description of the process in step S204 will be omitted.

In the examples in FIG. 15, one or more countermeasures are defined for each characteristic sₖ of the security information. However, the countermeasures may be redundant. Accordingly, a same ID for a group is given in advance to the countermeasures that are the same or similar. Then, in step S203, when the proposal unit 24 identifies a plurality of the countermeasures having the same ID for the group, the proposal unit 24 may propose only one countermeasure which represents that group. “ID” is an abbreviation for Identifier.

Description of Effect of Embodiment

According to this embodiment, an appropriate countermeasure can be automatically proposed, according to a result of estimation made by using information that can be automatically collected from an Internet 42 and a system 43 such as an intranet and indicating what type of the security incident a user targeted for evaluation is likely to cause.

Alternative Configuration

In this embodiment, the functions of the information collection unit 21, the model generation unit 22, the estimation unit 23, and the proposal unit 24 are implemented by the software, as in the first embodiment. However, as in the variation example of the first embodiment, the functions of the information collection unit 21, the model generation unit 22, the estimation unit 23, and the proposal unit 24 may be implemented by a combination of software and hardware.

### Third Embodiment

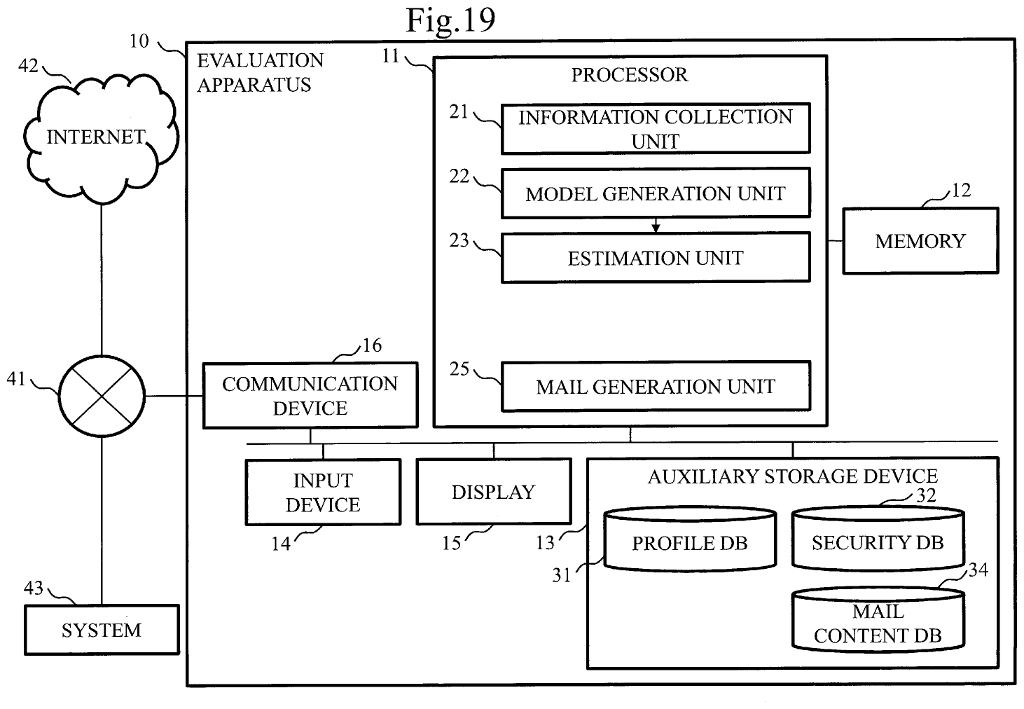

In this embodiment, a difference from the first embodiment will be mainly described, using FIGS. 19 to 22.

In the first embodiment, it is assumed that the security information which can be collected from the existing system 43 is used. On the other hand, in this embodiment, security information is acquired, using a result of transmission of a training mail whose content has been changed based on profile information of each user that has been collected.

Description of Configuration

A configuration of an evaluation apparatus 10 according to this embodiment will be described with reference to FIG. 19.

The evaluation apparatus 10 includes a mail generation unit 25 and a mail content database 34, in addition to an information collection unit 21, a model generation unit 22, an estimation unit 23, a profile database 31, and a security database 32. Functions of the information collection unit 21, the model generation unit 22, the estimation unit 23, and the mail generation unit 25 are implemented by software. Though the profile database 31, the security database 32, and the mail content database 34 may be constructed in a memory 12, the profile database 31, the security database 32, and the mail content database 34 are constructed in an auxiliary storage device 13 in this embodiment.

The mail content database 34 is a database to store the contents of one or more training mails.

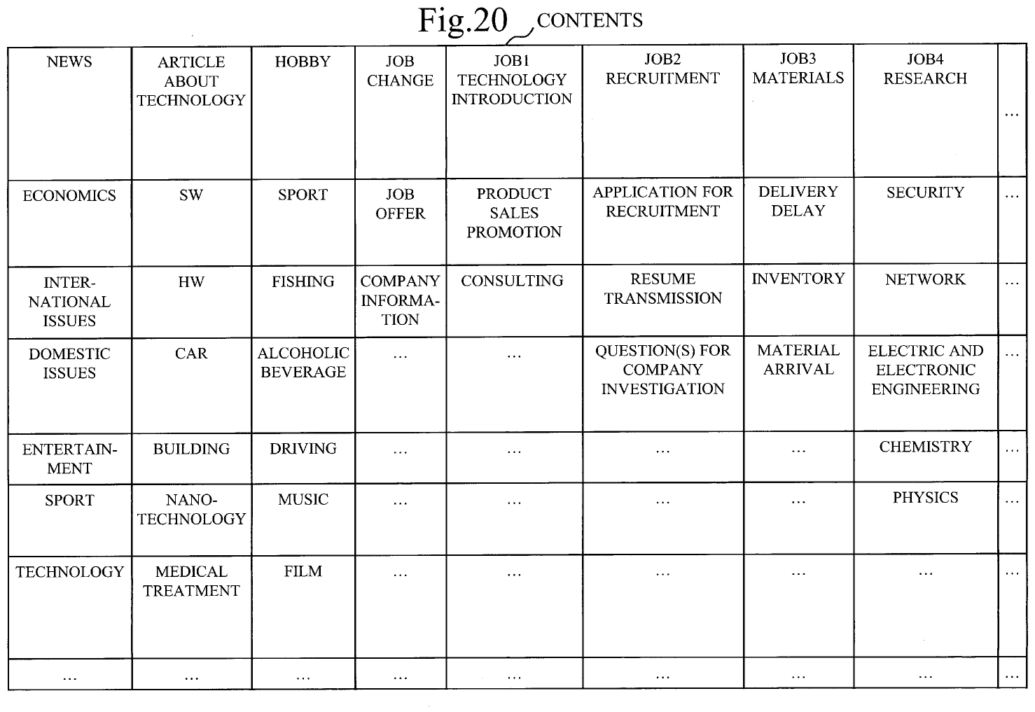

Examples of the contents are illustrated in FIG. 20. In these examples, some contents of the training mails are provided for each of topics such as news, a hobby, and a job, and are stored in the mail content database 34. To take an example, as the content of a training mail whose topic is the news, the content related to economics, international issues, domestic issues, entertainment, or the like is individually provided.

Description of Operations

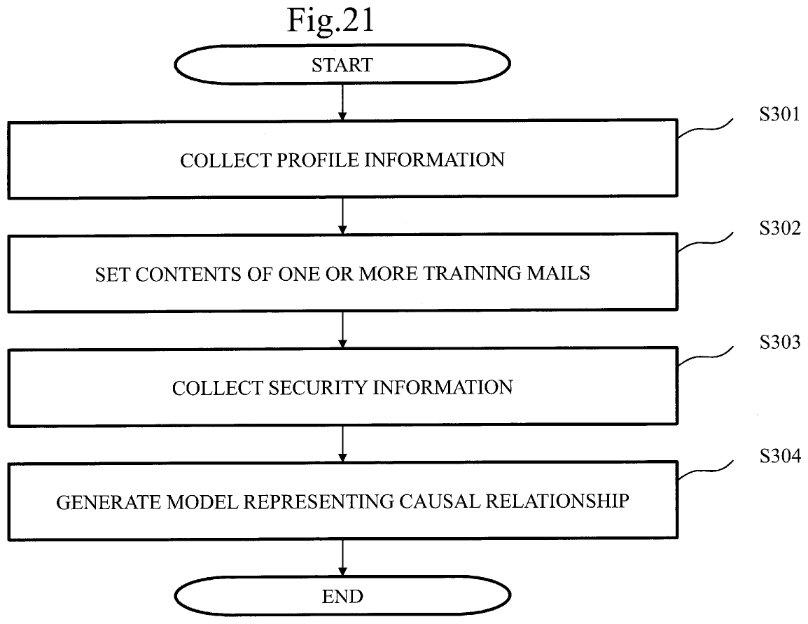

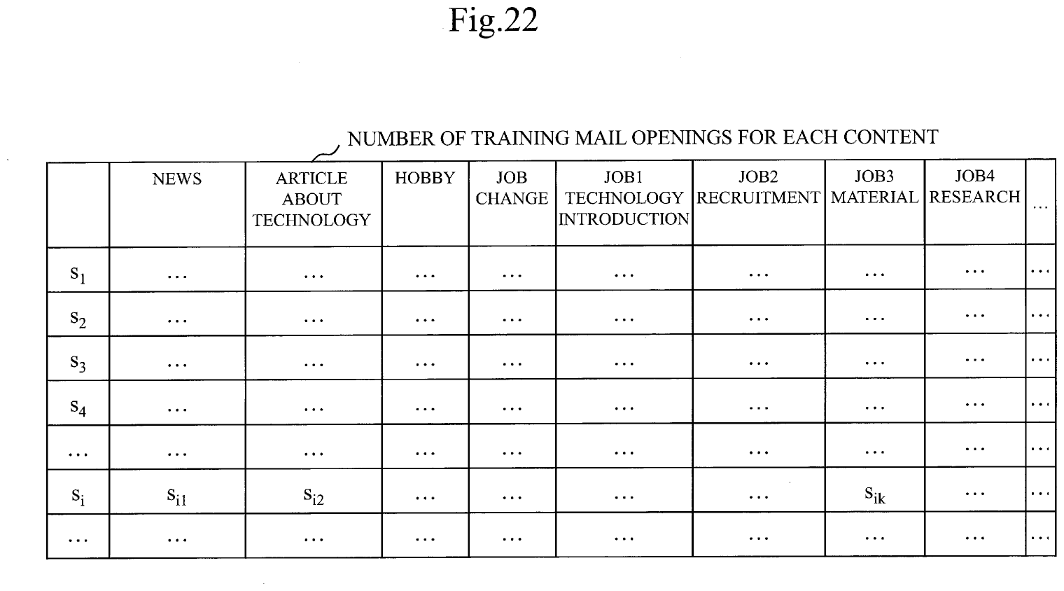

Operations of the evaluation apparatus 10 according to this embodiment will be described with reference to FIGS. 21 and 22, together with FIGS. 19 and 20. The operations of the evaluation apparatus 10 correspond to an evaluation method according to this embodiment.

FIG. 21 illustrates operations of a leaning phase.

In step S301, the information collection unit 21 collects profile information from both of an Internet 42 and a system 43 such as an intranet. The information collection unit 21 stores, in the profile database 31, the profile information collected. The profile information that is collected is the same as that which is collected in step S101 in the first embodiment.

In step S302, the mail generation unit 25 customizes the contents of one or more training mails stored in the mail content database 34, according to one or more characteristics indicated by the profile information that has been collected by the information collection unit 21.

Specifically, the mail generation unit 25 selects, from the mail content database 34, the content(s) related to the profile information that has been collected in step S301, for each staff of an organization. In this embodiment, the mail generation unit 25 acquires, out of the profile information of the staffs, the respective contents related to information of the job and an interest in particular, for each topic. The mail generation unit 25 generates a data set of the training mails including the contents that have been acquired.

In step S303, the mail generation unit 25 transmits the one or more training mails including the contents that have been customized in step S302 to each of a plurality of persons X₁, X₂, . . . , Xₙ. The mail generation unit 25 observes a behavior for each training mail that has been transmitted, thereby generating security information. The mail generation unit 25 stores, in the security database 32, the security information generated.

Specifically, the mail generation unit 25 periodically transmits, to each staff, the training mails in the data set that has been generated in step S302. The mail generation unit 25 registers the number of training mail openings for each topic in the security database 32, as the security information. With respect to the transmission of the training mails, an existing technology or an existing service such as the service described in Non-Patent Literature 4 can be used.

An example of a behavior observation result with respect to each training mail which is registered as the security information, is illustrated in FIG. 22. In this embodiment, the number of the training mail openings is registered in the security database 32 as the security information. The number of malware detections, the number of malicious site visits, the number of policy violations, the number of execution file downloadings, the number of file downloadings, and the number of Internet uses are collected by the information collection unit 21, as in step S101 in the first embodiment.

A process in step S304 is the same as the process in step S102. That is, in step S304, the model generation unit 22 generates a model representing a relationship between the profile information and the security information.

Since operations of an evaluation phase that is a phase subsequent to the learning phase are the same as those in the first embodiment, description of the operations of the evaluation phase will be omitted.

Description of Effect of Embodiment

According to this embodiment, the security information can be dynamically acquired.

Alternative Configuration

In this embodiment, the functions of the information collection unit 21, the model generation unit 22, the estimation unit 23, and the mail generation unit 25 are implemented by the software, as in the first embodiment. However, as in the variation example of the first embodiment, the functions of the information collection unit 21, the model generation unit 22, the estimation unit 23, and the mail generation unit 25 may be implemented by a combination of software and hardware.

### Fourth Embodiment

This embodiment is a combination of the second embodiment and the third embodiment.

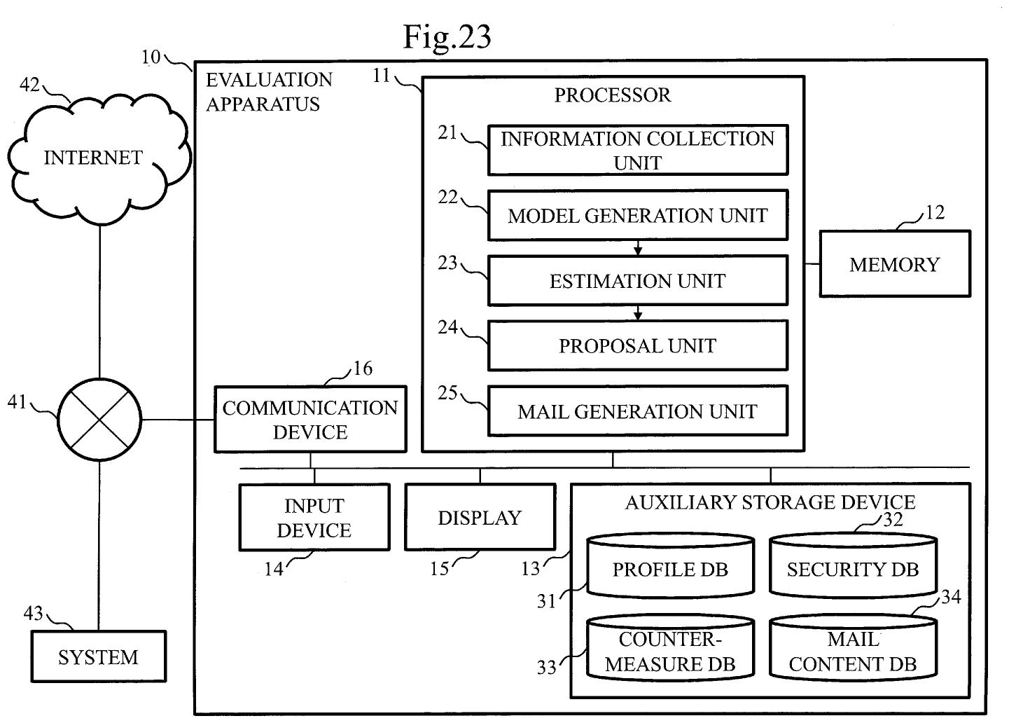

A configuration of an evaluation apparatus 10 according to this embodiment will be described with reference to FIG. 23.

The evaluation apparatus 10 includes a proposal unit 24, a mail generation unit 25, a countermeasure database 33, and a mail content database 34, in addition to an information collection unit 21, a model generation unit 22, an estimation unit 23, a profile database 31, and a security database 32. Functions of the information collection unit 21, the model generation unit 22, the estimation unit 23, the proposal unit 24, and the mail generation unit 25 are implemented by software. Though the profile database 31, the security database 32, the countermeasure database 33, and the mail content database 34 may be constructed in a memory 12, the profile database 31, the security database 32, the countermeasure database 33, and the mail content database 34 are constructed in an auxiliary storage device 13 in this embodiment.

Since the information collection unit 21, the model generation unit 22, the estimation unit 23, the mail generation unit 25, the profile database 31, the security database 32, and the mail content database 34 are the same as those in the third embodiment, description of the information collection unit 21, the model generation unit 22, the estimation unit 23, the mail generation unit 25, the profile database 31, the security database 32, and the mail content database 34 will be omitted.

Since the proposal unit 24 and the countermeasure database 33 are the same as those in the second embodiment, description of the proposal unit 24 and the countermeasure database 33 will be omitted.

### REFERENCE SIGNS LIST

10: evaluation apparatus; 11: processor; 12: memory; 13: auxiliary storage device; 14: input device; 15: display; 16: communication device; 21: information collection unit; 22: model generation unit; 23: estimation unit; 24: proposal unit; 25: mail generation unit; 31: profile database; 32: security database; 33: countermeasure database; 34: mail content database; 41: network; 42: Internet; 43: system; 51: profile information collection unit; 52: security information collection unit; 61: classification unit; 62: data generation unit; 63: learning unit.

1. An evaluation apparatus comprising:
a profile database to store profile information indicating an individual characteristic of each of a plurality of persons;
a security database to store security information indicating, by a number of signs of a security incident, a behavior characteristic of each of the plurality of persons, which may become a security incident factor; and
processing circuitry
to perform clustering of the profile information stored in the profile database, thereby classifying the plurality of persons into some clusters, to generate learning data from the profile information for each cluster, to compute, for each cluster, an average of the characteristic indicated by the security information stored in the security database as a label to be given to the learning data, and to derive a model representing a relationship between the characteristic indicated by the profile information stored in the profile database and the characteristic indicated by the security information stored in the security database, by using the learning data and the label to be given to the learning data; and
to supply, upon receipt of an input of information indicating a characteristic of a different person from the plurality of persons, the input information to the model derived by the processing circuitry and to determine the different person is likely to cause the security incident when a value of the label obtained by the model is equal to or more than a predefined value.

2. The evaluation apparatus according to claim 1,
wherein the processing circuitry computes, for each cluster, a standard deviation of the characteristic indicated by the security information and computes the average as the label to be given to the learning data when the standard deviation is held within a range defined in advance, and
wherein the processing circuitry determines that the different person is likely to cause the security incident when the average is obtained from the model and the value of the label obtained from the model is equal to or more than the predefined value.

3. The evaluation apparatus according to claim 1,
wherein the processing circuitry computes a correlation between the characteristic indicated by the profile information and the characteristic indicated by the security information before the processing circuitry derives the model, and excludes, from the profile information, the information indicating the characteristic for which the correlation computed is less than a threshold value.

4. The evaluation apparatus according to claim 1,
wherein the processing circuitry computes a correlation between the characteristic indicated by the profile information and the characteristic indicated by the security information before the processing circuitry derives the model, and excludes, from the security information, the information indicating the characteristic for which the correlation computed is less than a threshold value.

5. The evaluation apparatus according to claim 1, comprising:
a countermeasure database to store countermeasure information that defines one or more countermeasures against a security incident; and
the processing circuitry to identify a countermeasure against the security incident that may be caused by a behavior indicating the characteristic estimated, as the factor, by referring to the countermeasure information stored in the countermeasure database and to output information indicating the identified countermeasure.

6. The evaluation apparatus according to claim 1, further comprising:
the processing circuitry to collect the profile information from at least one of the Internet and a system that is operated by an organization to which the plurality of persons belong and to store the profile information in the profile database.

7. The evaluation apparatus according to claim 6,
wherein the processing circuitry collects the security information from the system and stores the security information in the security database.

8. The evaluation apparatus according to claim 1, comprising:
a mail content database to store content of a training mail that is a mail for performing training against the security incident; and
the processing circuitry to customize the content of the training mail stored in the mail content database according to the characteristic indicated by the profile information, to transmit, to each of the plurality of persons, the training mail including the content customized, to generate the security information by observing a behavior for the training mail transmitted, and to store the security information in the security database.

9. An evaluation method comprising:
by processing circuitry, acquiring, from a database, profile information indicating an individual characteristic of each of a plurality of persons and security information indicating, by a number of signs of a security incident, a behavior characteristic of each of the plurality of persons that may become a security incident factor, performing clustering of the profile information, thereby classifying the plurality of persons into some clusters, to generate learning data from the profile information for each cluster, to compute, for each cluster, an average of the characteristic indicated by the security information as a label to be given to the learning data, and deriving a relationship between the characteristic indicated by the profile information and the characteristic indicated by the security information, by using the learning data and the label to be given to the learning data; and
by the processing circuitry, upon receipt of an input of information indicating a characteristic of a different person from the plurality of persons, supplying the input information to the model derived and to determine the different person is likely to cause the security incident when a value of the label obtained by the model is equal to or more than a predefined value.

10. A non-transitory computer readable medium storing an evaluation program for a computer comprising a profile database to store profile information indicating an individual characteristic of each of a plurality of persons and a security database to store security information indicating, by a number of signs of a security incident, a behavior characteristic of each of the plurality of persons that may become a security incident factor, the evaluation program causing the computer to execute;
a model generation process of performing clustering of the profile information stored in the profile database, thereby classifying the plurality of persons into some clusters, to generate learning data from the profile information for each cluster, to compute, for each cluster, an average of the characteristic indicated by the security information stored in the security database as a label to be given to the learning data, deriving a model representing a relationship between the characteristic indicated by the profile information stored in the profile database and the characteristic indicated by the security information stored in the security database, by using the learning data and the label to be given to the learning data; and
an estimation process of supplying, upon receipt of an input of information indicating a characteristic of a different person from the plurality of persons, the input information to the model derived by the model generation unit and to determine the different person is likely to cause the security incident when a value of the label obtained by the model is equal to or more than a predefined value.
